(19) United States
(12) Patent Application Publication
(10) Pub. No.: US 2024/0422028 A1
(43) Pub. Date: Dec. 19, 2024

(54) APPARATUSES, METHODS, AND SYSTEMS FOR DYNAMIC CONTROL LOOP CONSTRUCTION

(71) Applicant: Lenovo (Singapore) Pte. Ltd., New Tech Park (SG)

(72) Inventor: Ishan Vaishnavi, München (DE)

(21) Appl. No.: 18/700,651

(22) PCT Filed: Oct. 11, 2022
(86) PCT No.: PCT/IB2022/059753

§ 371 Date: Apr. 11, 2024

Related U.S. Application Data
(60) Provisional application No. 63/254,286, filed on Oct. 11, 2021.

(51) Int. Cl. H04L 12/42

(52) U.S. Cl. CPC H04L 12/42

(57) ABSTRACT

Apparatuses, methods, and systems are disclosed for made-to-order closed loop construction. One embodiment of an apparatus or a network function (NF) entity includes a processor and a memory coupled with the processor. The processor is configured to cause the apparatus to receive, from a consumer device, a request to create a closed loop (CL) between a plurality of network entities, generate management services associated with the request for the CL, and transmit the generated management services to the consumer device.

### FIELD

The subject matter disclosed herein relates generally to wireless communications and more particularly relates to apparatuses, method, and systems for dynamic control loop (CL) construction.

### BACKGROUND

In certain wireless communications networks, a CL may be used.

### BRIEF SUMMARY

Methods for made-to-order (M2O) CL construction are disclosed. Apparatuses, systems, and network entities also perform the functions of the methods. One embodiment of an apparatus or a network function (“NF”) entity includes a processor and a memory coupled with the processor. The processor is configured to cause the apparatus to receive, from a consumer device, a request to create a closed loop (CL) process between a plurality of network entities, generate management services associated with the request for the CL process, and transmit the generated management services to the consumer device.

One embodiment of a method at a NF entity includes receiving, from a consumer device, a request to create a closed loop (CL) process between a plurality of network entities, generating management services associated with the request for the CL process, and transmitting the generated management services to the consumer device.

Another embodiment of an apparatus or a network function (“NF”) entity includes a processor and a memory coupled with the processor. The processor is configured to cause the apparatus to generate a request to create a closed loop (CL) process between a plurality of network entities, transmit the request to a network function (“NF”) entity, and receive a completed CL process from the NF entity.

Another embodiment of a method at a consumer device includes generating a request to create a closed loop (CL) process between a plurality of network entities, transmitting the request to a network function (“NF”) entity, and receiving a completed CL process from the NF entity.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for dynamic CL construction;

FIG. 2 is a schematic block diagram illustrating one embodiment of an apparatus that may be used for dynamic CL construction;

FIG. 3 is a schematic block diagram illustrating another embodiment of an apparatus that may be used for dynamic CL construction;

FIG. 4A is a schematic block diagram of an open control loop process:

FIG. 4B is a schematic block diagram of a closed control loop process:

FIG. 5A is a schematic block diagram of an exemplary closed control loop process:

FIG. 5B is a schematic block diagram of an exemplary closed control loop process:

FIG. 5C is a schematic block diagram of an exemplary closed control loop process:

FIG. 6 is a flow diagram of a process for generating non-made-to-order closed loop processes:

FIG. 7 is a flow diagram of a process for generating made-to-order closed loop processes:

FIG. 8 is a control diagram for a closed loop process:

FIG. 9 is a flowchart of a method performed by a network entity for generating closed loop processes; and

FIG. 10 is a flowchart of a method performed by a consumer device for requesting and receiving closed loop processes.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment.” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising,” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

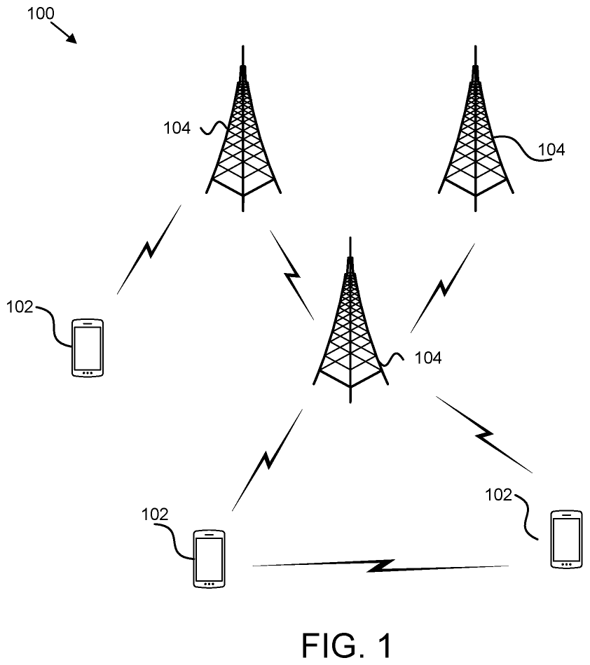

FIG. 1 depicts an embodiment of a wireless communication system 100 for dynamic CL construction. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (UE), user terminals, a device, or by other terminology used in the art. The remote units 102 may communicate directly with one or more of the network units 104 via uplink (UL) communication signals.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 3rd generation partnership project (“3GPP”) protocol, wherein the network unit 104 transmits using an orthogonal frequency division multiplex (“OFDM”) modulation scheme on the DL and the remote units 102 transmit on the UL using a SC-frequency division multiple access (“FDMA”) scheme or an OFDM scheme. More generally, however, the wireless communication system 100 may implement some other open or proprietary communication protocol, for example, worldwide interoperability for microwave access (“WiMAX”), among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

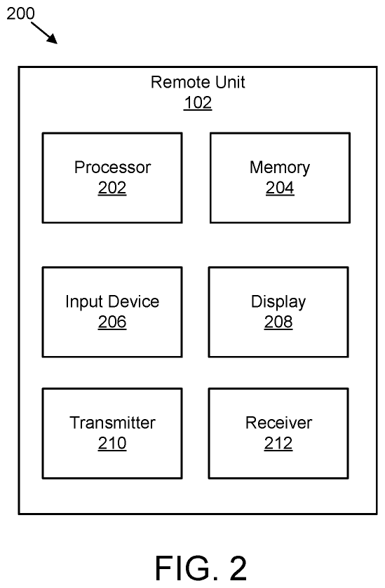

FIG. 2 depicts one embodiment of an apparatus (consumer) 200 that may be used for dynamic CL construction. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the network unit 104 and the receiver 212 is used to receive DL communication signals from the network unit 104, as described herein. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

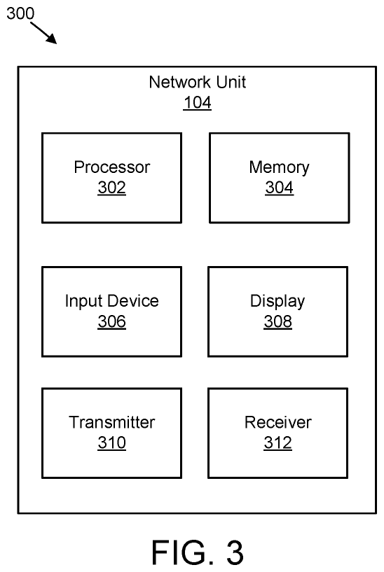

FIG. 3 depicts one embodiment of an apparatus (network function (“NF”) entity) 300 that may be used for dynamic CL construction. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively. The functionality provided by the apparatus 300 may be distributed across a multiple NF entities couple to a public or a private data network.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In one embodiment, a network unit (apparatus or NF entity) performs dynamic CL construction. The apparatus includes a processor and a memory coupled with the processor. The processor is configured to cause the apparatus to receive, from a consumer device, a request to create a closed loop (CL) process between a plurality of network entities, generate management services associated with the request for the CL process, and transmit the generated management services to the consumer device.

In certain embodiments, a remote unit (apparatus) includes a processor and a memory coupled with the processor. The processor is configured to cause the apparatus to generate a request to create a closed loop (CL) process between a plurality of network entities, transmit the generated management services to a network function (“NF”) entity, and receive a completed CL process from the NF entity.

Closed loops run in operator networks try to optimize individual goals for closed loop consumers. These consumers maybe human or software entities. Different network operators may want to automate their closed loops differently. Some may want to consolidate data before analysis, while others may run the data through multiple machine learning models simultaneously. Closed loops may be designed to have an infinite number of variations. Traditionally closed loops were first proposed as observe-orient-decide-act (“OODA”) loops having 4 stages: Observe, Orient, Decide, and Act. Other closed loops including more stages appeared later. Monitor, Analyze, Plan, Execute-Knowledge (“MAPE-K”) includes an additional knowledge sharing component stage. The Observe, Normalize, Compare, Decide, Act, Reason, and Learn (“FOCALE”) loop creates a multiple set of acceptable network states for the closed loop by adding further stages to translate monitored data to a uniform format and to apply the current network context to the observations prior to further analysis of the data. Currently however, there is no solution for closed loops construct based on user requirements in 3GPP.

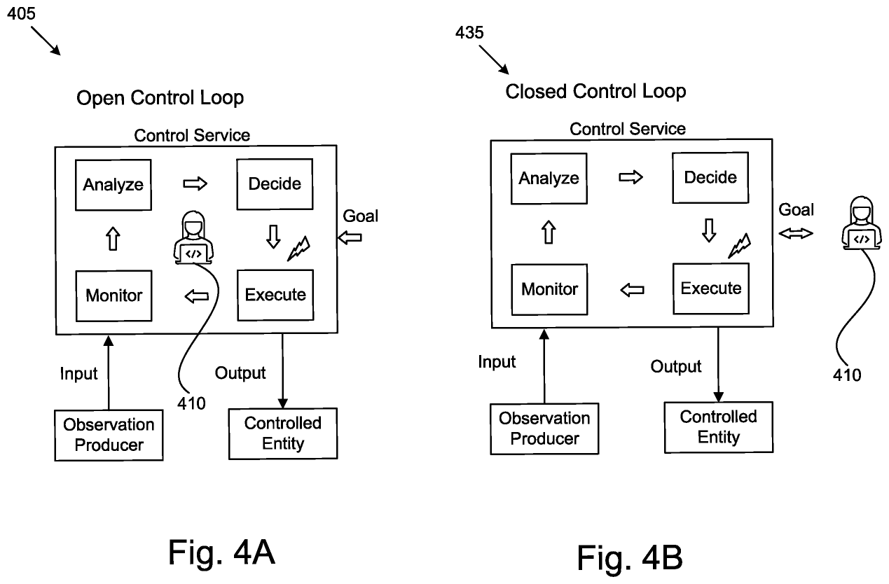

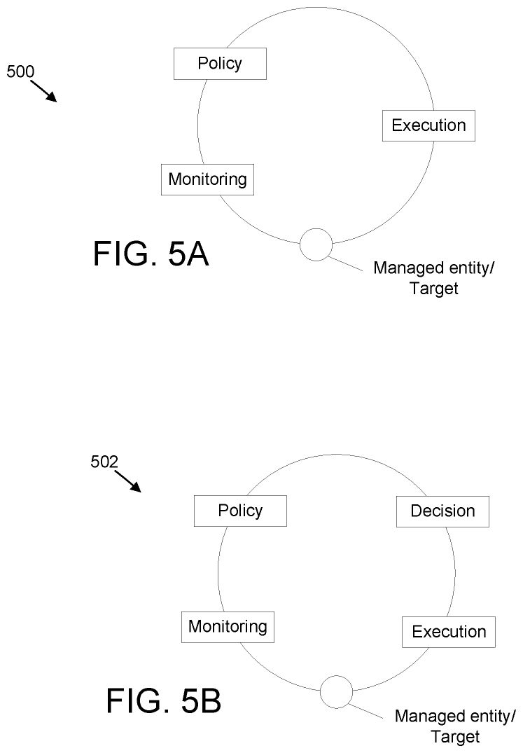

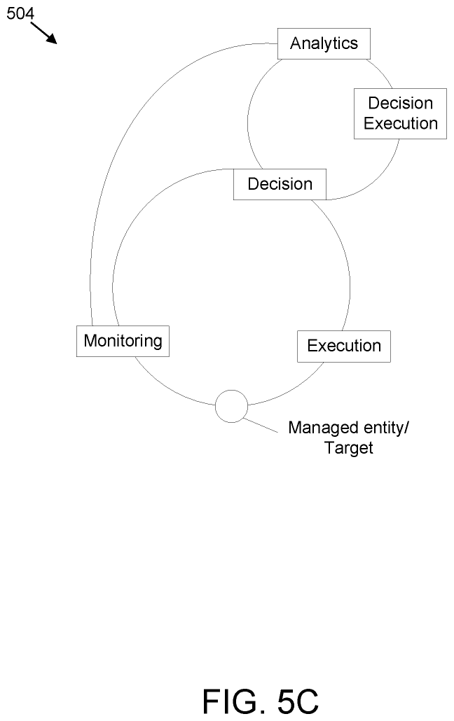

An example open control loop 405 and an example closed control loop 435 are shown in FIGS. 4A and 4B. The open loop 405 involves an operator 410 to be a part of at least one of the stages in the loop, while in the closed loop 435, the operator 410 only defines a goal for the closed control loop 435 and the loop 435 is configured to run automatically. FIG. 4B shows only the basic operations of a closed loop (“CL”), however, CLs may be complex entities and examples of closed loops are shown in FIGS. 5A-C.

Referring to FIG. 5A, a closed loop 500 is a simple policy-based closed loop where key performance indicator (“KPI”) threshold maybe configured over the monitoring data to activate pre-configured policies that issue execution command to a managed entity. Referring to FIG. 5B, a closed loop 502 includes an analytics and a decision phase, which may be based on some artificial intelligence (“AI”) and machine learning based decision taking. Referring to FIG. 5C, a closed loop 504 includes a set of a fast and slow CLs. The fast CL works on pre-defined policy-based decisions and the outer slow loop analyses the effect of the decision on the network and may execute changes in how the fast loop makes decisions. For simplicity only one managed entity is shown. There may be many.

Collection and ordering of components within a CL is referred to as a chain that forms the CL. The exchange of data and control messages between the various components of the CL chain are referred to as a flow in the CL. There may be multiple flows running concurrently in a CL chain. Together the CL chain and how they determine the flow of messages between the CL components in the chain determine the behavior of the CL.

Network policies are a set of rules that provide a mechanism for default decisions to be taken without human intervention in the network. Typically, they are organized as event-action(s) or event-condition-action(s) tuples. If the event is an occurrence in the network, a condition is a constraint to be met and action(s) are a list of configurations or changes to be carried out when the event happens, and the conditions, if specified, are met.

Policies are frequently used in many places in network management and operations to take automatic decisions. A policy-based decision stage includes an event, condition, and action (“ECA”) tuple. When an event is detected in the network and a set of specific conditions is met the actions specified by the ECA policy are carried out by a policy enforcer. The actions essentially are a “decision” to be executed in the network. Currently, there is no way to simultaneously compare one action with another in an operation network. One of either the condition or the event may be missing in a description of the policy.

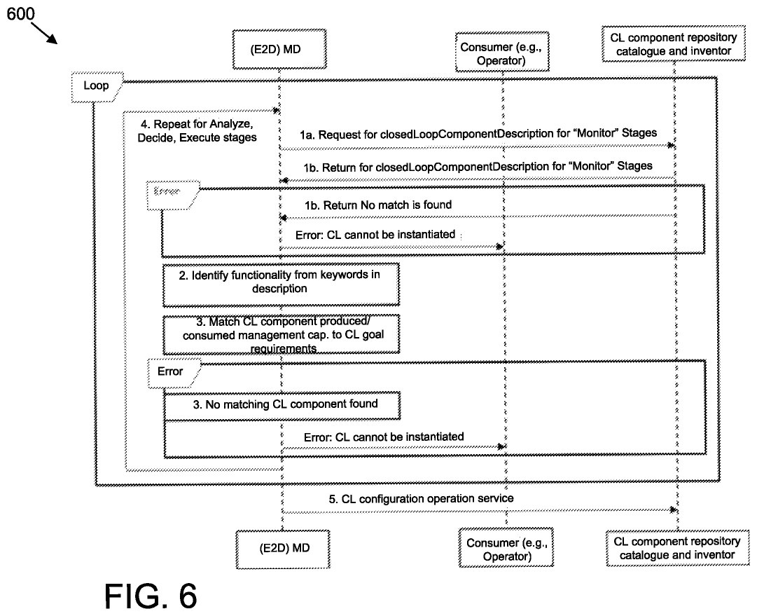

Referring to FIG. 6, a method 600 shows construction of CLs, see also Table 1. In an operator network, a M2O-CL is needed to monitor KPIs (KPI1, KPI2, . . . etc.) and control parameters (P1, P2, . . . etc.) of managed entities (ME1, ME2, . . . etc.). A request for instantiating a new M2O-CL can include information to help end-to-end (“E2E”) management domain (“MD”) match CL components to a CL goal. This information can be in the form of a partially filled CL instance information model or the E2E MD receives a partially filled CL instance information model and uses this information to construct a suitable M2O-CL. Basic assembly uses four CL stages (i.e. Monitor, Analyze, Decide, Execute). The set of stages that compose a M2O-CL must include at least one Monitor stage and one Execution stage. In one example, a new M2O-CL is prepared and instantiated with the goal of monitoring relevant KPIs, within a specific scope, generating recommendations for network resource/KPI optimization and triggering their execution.

TABLE 1

| Solution alternative | Needed Ability (NA) Reference |
|---|---|
| Loop: For each CL stage (Monitor, Analyse, Decide, | Step 1, 3, 4 : NA - Ability of E2E |
| Execute) Do | MD to request/read for an attribute or |
| Step 1: E2E MD sends a request to CL component | a set of attributes of a set of CL Class |
| repository catalogue and inventory for generating a | instances or descriptors with certain |
| description of CL components that can fit in the | filters. |
| Monitor stage. In case no match is found for the | Step 2: NA - Ability of E2E MD to |
| Monitor stage, an error is returned “CL cannot be | identify predefined keywords used in |
| instantiated: No matching Monitor stage CL component | the description of CL components to |
| not found”. In this case, the zero touch network and | enable easy detection of functionality. |
| service management (“ZSM”) framework may procure | Step 5: Ability of E2E MD to assign |
| and install new/additional functionality (e.g. software or | multiple CL components to a |
| hardware implemented management functions (“MnFs”, | new/existing M2O-CL instance and |
| CL components) to provide the capabilities that were | configure/update other attributes of |
| missing and submit a new request. | the M2O-CL instance, i.e., a target |
| Step 2: E2E MD identifies the exact functionality of | entity list, etc., and trigger CL |
| each component by detecting keywords in the | configuration operations services. |
| description of the CL components. This can be a | |
| predefined and standardized list of keywords for easy | |
| functionality detection. | |
| Step 3: E2E MD selects the CL component that is | |
| functionally compatible with the CL goal. This is | |
| identified from a produced management capabilities list | |
| and a consumed management capabilities list. An input | |
| data list must match an output data list between | |
| subsequent CL components. In case no match is found, | |
| then an error is returned “CL cannot be instantiated. | |
| unsupported operations/data type”. In this case, the | |
| ZSM framework may procure and install new/additional | |
| functionality (e.g. software or hardware implemented | |
| MnFs, CL components) to provide the capabilities that | |
| were missing and submit a new request. | |
| Step 4: E2E MD repeats steps 1 to 3 for the other 3 | |
| stages (Analyse, Decide, and Execute) composing the | |
| M2O-CL. | |
| Step 5: after identifying all components of the M2O-CL, | |
| the instance of a CL is updated with information such | |
| as: closedLoopLifeCyclePhase = preparation, | |
| closedLoopComponentList = identified | |
| components. .etc. | |
| trigger CL configuration operation service. | |
| If E2E MD fails to identify one of the stages needed | |
| “X”, an error is returned “CL cannot be instantiated: X | |
| stage CL component not found”. In this case, the ZSM | |
| framework may procure and install new/additional | |
| functionality (e.g. software or hardware implemented | |
| MnFs) to provide the capabilities of stage “X” that is | |
| missing and submit a new request. | |

Certain embodiments may be incomplete and not actually implementable as the method 600 doesn't describe how one stage connects to another and only describes a way in which stages that form the CL can be selected. The method 600 doesn't describe how individual stages are configured for a specific CL nor how the stages are connected to each other.

In various embodiments, management services, components, or stages) may be searched for and configured to make up the CL based on characteristics of the CL. The configuration provides conditions that trigger flows of message within the CL. Also, conditions and messages are generated based on the CL characteristics.

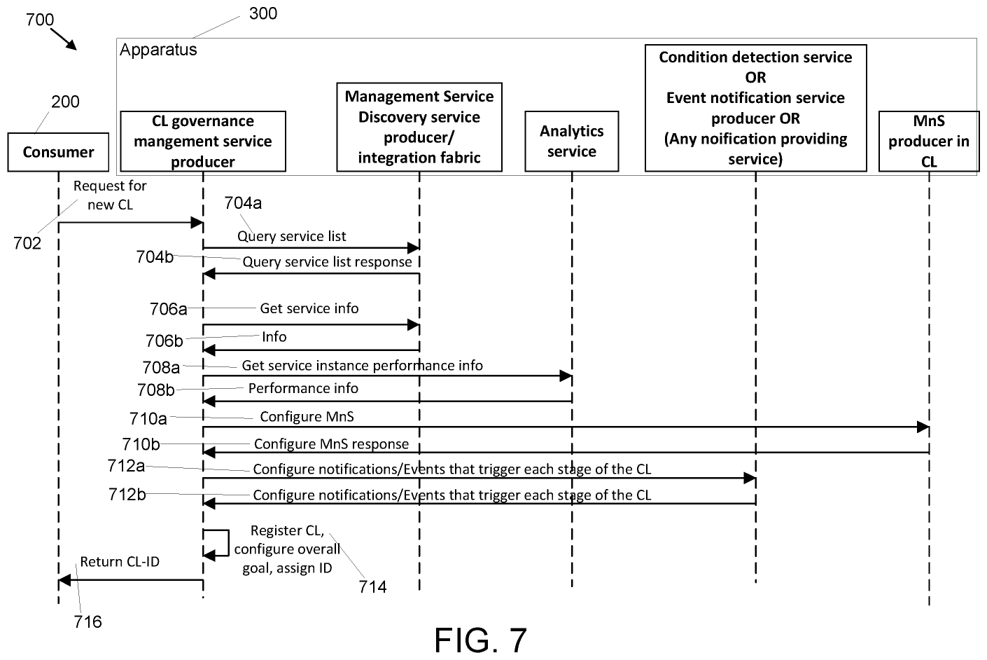

In various embodiments, a first part determines CL components that form a chain of a CL. The second part configures those CL components to determine how messages flow between the CL components in the chain. CL components include management functions or implementation of management services. Referring to FIG. 7, in various embodiments, a method 700 describes more specifically M2O CL generation. At a step 702, a request from a consumer 200 is received at an apparatus (NF entity) 300 for creating a CL with a specific description of the components of the CL and how the CL components relate to one another (i.e., the chain of the CL and how data flows within the CL chain). The request includes components and stages in a CL. The request also includes the messages sent from one stage to another and the conditions under which those messages are sent. The request may additionally include timeouts or time periods for various aspects/components/stages of the CL. The request may further include functional and performance characteristics for the CL or parts of the CL chain. The functional and performance characteristics may be used to identify the CL components.

At a step 704a, a query service list or an equivalent management services (MnS) discovery service is queried. An example query service list includes ETSI ZSM GS 002. At a step 704b, a response includes a location of the found MnS and addresses where the configure and access those MnS implementations. Not all the MnS on a stored MnS list are relevant to the request. All management services are registered to the management service discovery service entity (producer). The management service discovery service entity includes all the information about all management services. Also, a MnS producer is a management service that is fetched at step 704a,b.

At a step 706a,b, services (access) information associated with the MnS implementation are retrieved. The services information could be related to functionality provided by an MnS (e.g., the typical delay taken by the MnS to respond.)

At a step 708a,b, service instance performance information is retrieved form an analytics service. Based on what information is fetched in steps 706 and 708, a short list of a set of MnS (a smaller short list) is generated. These MnS in the short list form the CL.

At a step 710a,b, an MnS producer is configured to participate in the CL depending on the MnS. The MnS producer performs configuring of the MnS that are going to be a part of the closed loop. The configured MnS become a part of the new closed loop. The configuring of the MnS provides instructions to the analytics service what action (output) an entity performs based the input that entity receives and what other configured MnS that output gets sent to. Step 710a,b configures what kind of analytics, i.e., what input, what output. At step 712a,b, the kind of notifications that has to be send to what entity and what does it have to react to are configured. When a notification is sent to another entity, it is determined what other entity is to react to that notification.

Step 710a,b may be merged with steps 704a,b or performed by a conditioned detection service at step 712a,b as part of configuring the conditions. An example of such configuration is configuring a monitoring or performance MnS producer to collect KPIs.

For every MnS implementation in the CL, conditions, events, timeouts, or any other set of notifications are configured such that the CL component functions correctly in accordance with requested overall functionality and performance of the CL. In turn the conditioned detection service may need to provision the MnS themselves.

The entity that is producing the MnS producer could also produce other management services. The CL governance management service producer could be integrated with the discovery management service producer. European Telecommunications Standards Institute (ETSI) in their technical specification (TS 128 533 V15.3.0) describes the relationship between MnS and MnS producers.

At a step 714, the CL is now created and now the overall goal of the CL is configured. Further internal management such as assigning an identifier to uniquely identify the CL is also done at the step 714.

At a step 716, the identifier of the CL together with the configured MnS and notifications/events are returned to the consumer 200.

In various embodiments, the functionality of creating a CL is located with the CL governance service entity. In other embodiments a separate CL creation service that coordinates with the CL governance service is provided for creating CLs.

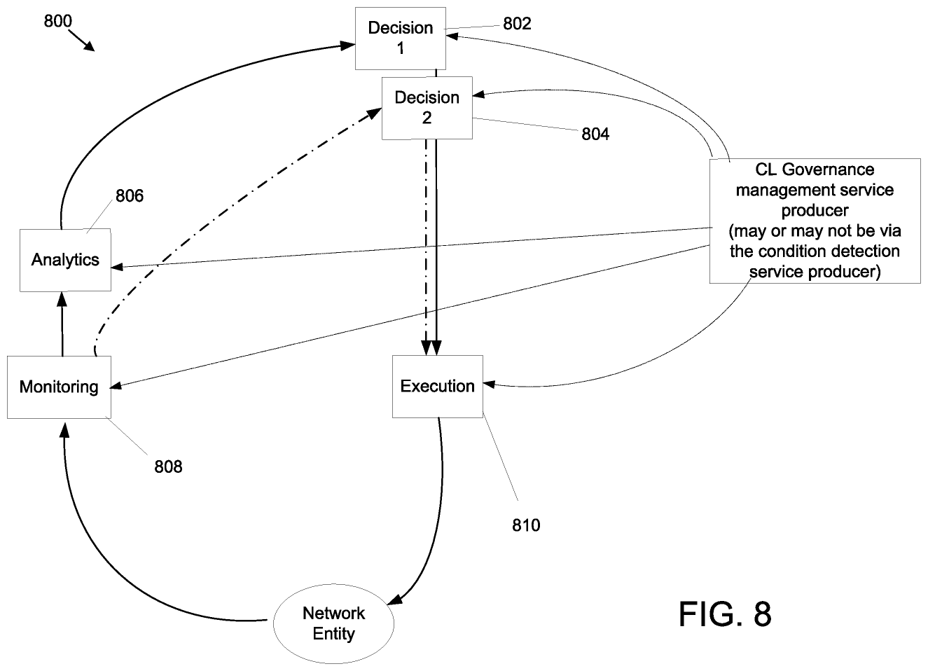

Referring to FIG. 8, in various embodiments, a process 800 shows different components of the sea L being configured by the CL governance service (steps 710a,b of FIG. 7). For example, a Monitoring stage 808 is configured for monitoring data for the CL, while an Analysis stage 806 is configured with a model to be used that the decisions are configured with the mechanism to make decisions and executions with what is allowed to configure and what is not allowed.

At step 712a,b, the connections or information of how messages flow through stages or components 806, 808, 810 are configured, thus creating the chains in the CL. The Monitoring stage 808 is configured with a timeout that triggers a collection of data and thresholds that send notifications to a Decision 2 component 804. The Decision 2 component 804 in step 712a,b is configured with a mapping of notification from the Monitoring stage 808 corresponding decisions to be sent to an Execution stage 810 this creates a shorter quick response loop in this example, while a longer analytics-based loop also exists via a Decision 1 component 802.

There could be any number of components and states connected in any way possible. Further enhancement can include a knowledge component where all other components periodically register configured aspects. There could be an extension of the closed loop to another closed loop which itself monitors the performance of this closed loop.

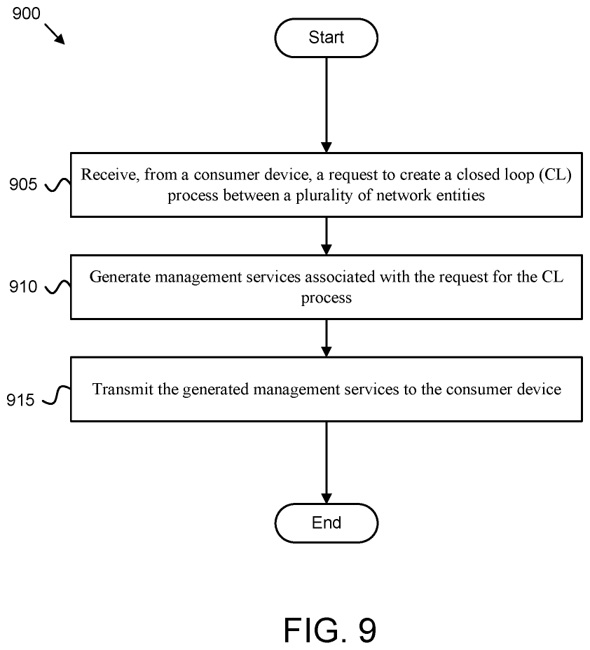

Referring to FIG. 9, a flow diagram of a method 900 performed at a network entity. At a block 905, a request to create a CL process between a plurality of network entities is received from a consumer device. At a block 910, management services associated with the request for the CL process are generated based on information included in the request. At a block 915, the generated management services are transmitted to the consumer device.

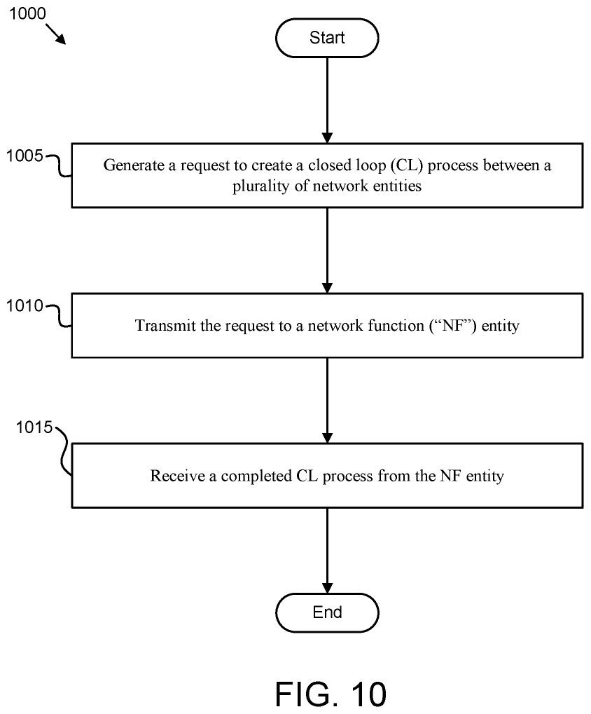

Referring to FIG. 10, a flow diagram of a method 900 performed at a network entity. At a block 1005, a request to create a closed loop (CL) process between a plurality of network entities is generated. At a block 1010, the generated request is transmitted to a network function (“NF”) entity. At a block 1015, a completed CL process is received from the NF entity.

A. An apparatus comprising: a processor; and a memory coupled with the processor, the processor configured to cause the apparatus to: receive, from a consumer device, a request to create a closed loop (CL) between a plurality of network entities: generate at least one management service associated with the request for the CL; and transmit the generated management services to the consumer device.

B. The apparatus of A, wherein the request comprises a description of a desired behavior of the CL or components of the CL.

C. The apparatus of B, wherein the description of components in the CL comprises properties of messages, requirement for the messages, or messages to be sent between stages of the CL.

D. The apparatus of C, wherein the description of components in the CL comprises conditions for the messages to be sent between the components or the stages.

E. The apparatus of any of B-D, wherein the request includes timeouts, time periods, or both for the messages to be sent between the stages of the CL.

F. The apparatus of any of B-E, wherein the processor is further configured to identify a shortlist of management services from a previously generated list of management services based on the request, the desired behavior of the CL, the components, or the stages.

G. The apparatus of any of C-F, wherein the processor is further configured to generate notifications, events, or both for triggering each stage of the CL.

H. The apparatus of G, wherein the processor is further configured to generate a goal for the CL process.

I. The apparatus of any of A-H, wherein the processor is further configured to cause the apparatus to: generate a CL identifier for the CL; and transmit the CL identifier to the consumer device.

J. A method at a network function (“NF”) entity, the method comprising: receiving, from a consumer device, a request to create a closed loop (CL) between a plurality of network entities: generating at least one management service associated with the request for the CL; and transmitting the generated management services to the consumer device.

K. The method of J, wherein the request comprises a description of a desired behavior of the CL or components of the CL.

L. The method of K, wherein the description of components in the CL comprises properties of messages, requirement for the messages, or messages to be sent between stages of the CL.

M. The method of L, wherein the description of components in the CL comprises conditions for the messages to be sent between the components or the stages.

N. The method of any of K-M, wherein the request includes timeouts, time periods, or both for the messages to be sent between the stages in the CL.

O. The method of any of J-N, wherein generating management services comprises identify a shortlist of management services from a previously generated list of management services based on the request, the desired behavior of the CL, the components, or the stages.

P. The method of any of L-O, wherein generating management services comprises generating notifications, events, or both for triggering each stage of the CL.

Q. The method of P, wherein generating configurations of management services comprises generating a goal for the CL.

R. The method of any of J-Q, further comprising: generating a CL identifier for the CL; and transmitting the CL identifier to the consumer device.

S. An apparatus comprising: a processor; and a memory coupled with the processor, the processor configured to cause the apparatus to: generate a request to create a closed loop (CL) between a plurality of network entities: transmit the request to a network function (“NF”) entity; and receive a completed CL from the NF entity.

T. The apparatus of S, wherein the request comprises a description of a desired behavior of the CL or components of the CL.

U. The apparatus of T, wherein the description of components in the CL comprises properties of messages, requirement for the messages, or messages to be sent between stages of the CL.

V. The apparatus of U, wherein the description of components in the CL comprises conditions for the messages to be sent between the components or the stages.

W. The apparatus of S, wherein the request includes timeouts, time periods, or both for the messages to be sent between the stages of the CL.

X. A method at a consumer device, the method comprising: generating a request to create a closed loop (CL) between a plurality of network entities: transmitting the request to a network function (“NF”) entity; and receiving a completed CL from the NF entity.

Y. The method of X, wherein the request comprises a description of a desired behavior of the CL or components of the CL.

Z. The method of Y, wherein the description of components in the CL comprises properties of messages, requirement for the messages, or messages to be sent between stages of the CL.

AA. The method of Z, wherein the description of components in the CL comprises conditions for the messages to be sent between the components or the stages.

AB. The method of Y, wherein the request includes timeouts, time periods, or both for the messages to be sent between the stages of the CL.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
receive, from a consumer device, a request to create a closed loop (CL) between a plurality of network entities;
generate at least one management service associated with the request for the CL;
generate a CL identifier for the CL based on successfully generating the at least one management service for the CL; and
transmit the CL identifier to the consumer device or a failure message indicating unsuccessfully generating the at least one management service for the CL.

2. The apparatus of claim 1, wherein the request comprises a description of a desired behavior of the CL or components of the CL.

3. The apparatus of claim 2, wherein the description of components in the CL comprises properties of messages, requirement for the messages, or messages to be sent between stages of the CL.

4. The apparatus of claim 3, wherein the description of components in the CL comprises conditions for the messages to be sent between the components or the stages.

5. The apparatus of claim 2, wherein the request includes timeouts, time periods, or both for the messages to be sent between the stages of the CL.

6. The apparatus of claim 2, wherein the at least one processor is configured to cause the apparatus to identify a shortlist of management services from a previously generated list of management services based on the request, the desired behavior of the CL, the components, or the stages.

7. The apparatus of claim 3, wherein the at least one processor is configured to cause the apparatus to generate notifications, events, or both for triggering each stage of the CL.

8. The apparatus of claim 7, wherein the at least one processor is configured to cause the apparatus to generate a goal for the CL process.

9. (canceled)

10. (canceled)

11. (canceled)

12. (canceled)

13. (canceled)

14. (canceled)

15. A user equipment (UE), comprising:
at least one memory; and
at least one processor coupled with the at least one memory and configured to cause the UE to:
generate a request to create a closed loop (CL) between a plurality of network entities;
transmit the request to a network function (NF) entity; and
receive an identifier associated with a completed CL from the NF entity or an indication that generation of the CL failed.

16. The UE of claim 15, wherein the request comprises a description of a desired behavior of the CL or components of the CL.

17. The UE of claim 16, wherein the description of components in the CL comprises properties of messages, requirement for the messages, or messages to be sent between stages of the CL.

18. The UE of claim 17, wherein the description of components in the CL comprises conditions for the messages to be sent between the components or the stages.

19. The UE of claim 16, wherein the request includes timeouts, time periods, or both for the messages to be sent between the stages of the CL.

20. A processor for wireless communication, comprising:
at least one controller coupled with at least one memory and configured to cause the processor to:
generate a request to create a closed loop (CL) between a plurality of network entities;
transmit the request to a network function (NF) entity; and
receive an identifier associated with a completed CL from the NF entity or an indication that generation of the CL failed.

21. The processor of claim 20, wherein the request comprises a description of a desired behavior of the CL or components of the CL.

22. The processor of claim 21, wherein the description of components in the CL comprises properties of messages, requirement for the messages, or messages to be sent between stages of the CL.

23. The processor of claim 22, wherein the description of components in the CL comprises conditions for the messages to be sent between the components or the stages.

24. The processor of claim 21, wherein the request includes timeouts, time periods, or both for the messages to be sent between the stages of the CL.

25. A method performed by a user equipment (UE), the method comprising:
at least one controller coupled with at least one memory and configured to cause the processor to:
generate a request to create a closed loop (CL) between a plurality of network entities;
transmit the request to a network function (NF) entity; and
receive an identifier associated with a completed CL from the NF entity or an indication that generation of the CL failed.

26. The method of claim 25, wherein the request comprises a description of a desired behavior of the CL or components of the CL.
